(19) United States
(12) Patent Application Publication
(10) Pub. No.: US 2014/0313801 A1
(43) Pub. Date: Oct. 23, 2014

(54) CONTROLLED RECTIFIER WITH A B2 BRIDGE AND ONLY ONE SWITCHING DEVICE

(71) Applicant: Paul Vahle GmbH & Co. KG, Kamen (DE)

(72) Inventor: Faical Turki, Bergkamen (DE)

(21) Appl. No.: 14/360,479

(22) PCT Filed: Oct. 22, 2012
(86) PCT No.: PCT/EP2012/070852

§ 371 Date: May 23, 2014

(30) Foreign Application Priority Data
Nov. 24, 2011 (DE) 10 2011 119 261.5

(51) Int. Cl. H02M 7/06

(52) U.S. Cl. CPC H02M 7/06
USPC 363/126

(57) ABSTRACT

The invention relates to a secondary side rectifier of an inductive energy transmission system, wherein the energy transmission system has a single-phase resonant tuned circuit, which has at least one inductor (L) and at least one capacitor and can be magnetically coupled to a primary side resonant tuned circuit, and wherein the secondary side rectifier has a B2 bridge circuit, which Consists of four diodes (D1, D2, D3, D4) and is connected on the input side to the secondary side resonant tuned circuit, and the output voltage of which is smoothed by at least one smoothing capacitor (C_{gr}), characterised in that a switching means (S) is connected in parallel with a diode (D1, D2, D3, D4), by means of which the diode (D1, D2, D3, D4) can be short-circuited.

The invention relates to a secondary side rectifier of an inductive energy transmission system, wherein the energy transmission system has a single-phase resonant circuit, which has at least one inductor and at least one capacitor and can be magnetically coupled to a primary side resonant tuned circuit, and wherein the secondary side rectifier has a B2 bridge circuit, which consists of four diodes and is connected on the input side to the secondary side resonant circuit, and the output voltage of which is smoothed by at least one smoothing capacitor.

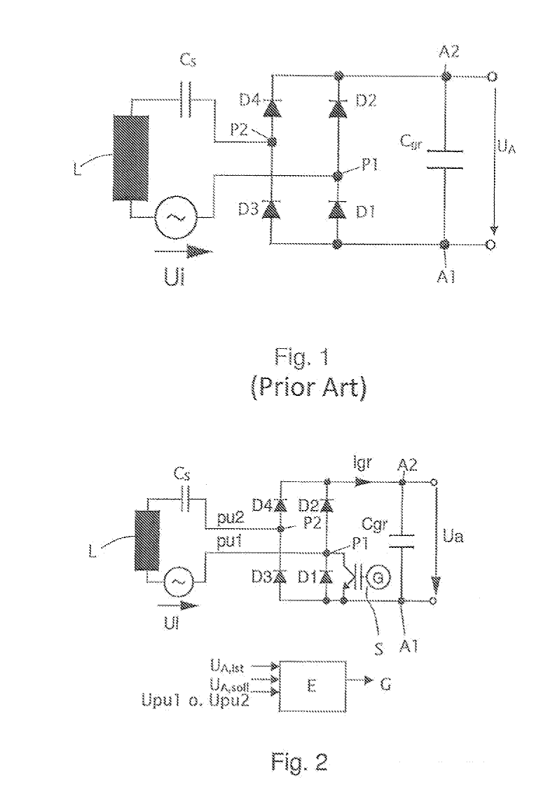

In contactless energy transmission, an induced voltage in the secondary circuit of an air gapped transformer is generally rectified, the resulting DC voltage subsequently being used to supply loads. A simple rectifier in this case consists of a B2 bridge comprising of four diodes D1-D4 and an additional smoothing capacitor, as represented in FIG. 1. The rectifier generates a DC voltage, which is primarily dependent on the coupling to the primary circuit, as well as on the load. When a constant DC voltage is required, the variable rectifier voltage U_{A} may be regulated by means of a DC/DC converter (not shown). The voltage induced in the resonant circuit is represented by the equivalent voltage source Uᵢ. The transmission frequency of the energy transmission system when using resonant circuits is in the kHz range.

The rectifier described above is also suitable for rectifying an inductive energy transmission system that has a single-phase primary side resonant circuit and a single-phase secondary side resonant circuit, which are magnetically coupled to one another. The resonant circuits may be formed as parallel or series circuits, consisting of inductors and capacitors.

It is an object of the present invention to provide a controlled secondary side rectifier with the output voltage can be regulated or adjusted, and which consists of few components.

This object is achieved according to the invention by a secondary side rectifier having the features of claim 1. Other advantageous configurations of the rectifier according to the invention are given by the features of the dependent claims.

The secondary side rectifier according to the invention is advantageously distinguished in that it requires only one controlled switching means, with which it is possible to switch to and fro between two modes. The switching means is connected in parallel with one of the diodes of the B2 bridge. When the switching means is open, the parallel diode is not short-circuited, so that the secondary side rectifier operates as a conventional uncontrolled B2 bridge rectifier. In this mode, there is therefore full bridge rectification. This typically delivers simple peak value rectification of the AC value, with

U_{A}=√2*Uᵢ in no-load operation.

In the second mode, the diode is short-circuited by means the switching means, so that the rectifier operates together with the at least one capacitor of the secondary side resonant circuit as a voltage doubler. In the second mode, the doubled voltage value U_{A}=2*√2*Uᵢ is set up after several oscillation periods of the resonant circuit in no-load operation.

By the on-state time of the switching means, it is therefore possible to switch the output voltage between the values U_{A,min}=√2*Uᵢ and U_{A,max}=2*√2*Uᵢ, or permanently to U_{A,min} or U_{A,max}.

It is in this case advantageous for the switching means to be soft-switched, that is to say no current flows through the switching means when it switched, and it is switched without voltage. This leads to advantageously low switching losses. It is, however, also possible for the switching means to be hard-switched.

The secondary side rectifier according to the invention therefore allows regulation of the output voltage in a sufficiently large adjustment range with only one additional switching means. The one switching means therefore advantageously replaces an otherwise required DC/DC converter.

The rectifier according to the invention is distinguished because of the few components required and by a compact design and low weight, and it is furthermore favourable in terms of production.

Owing to the possibility of operating the rectifier in voltage doubler mode, the reactive power in the secondary side resonant tuned circuit can advantageously be reduced, since the resonant capacitors merely need to be dimensioned for the sum of the active voltage and half the reactive voltage of the conventional passive rectifier.

If the rectifier according to the invention is used in a pickup, the latter can advantageously be dimensioned smaller and manufactured more favourably. The invention likewise claims an energy transmission system and a pickup, which the secondary rectifier according to the invention is used.

The rectifier according to the invention will be explained in more detail below with the aid of drawings, in which:

FIG. 1 shows an uncontrolled B2U bridge rectifier supplied by a secondary side resonant circuit;

FIG. 2 shows a controlled secondary side bridge rectifier according to the invention with a switching element selectively short-circuiting a diode;

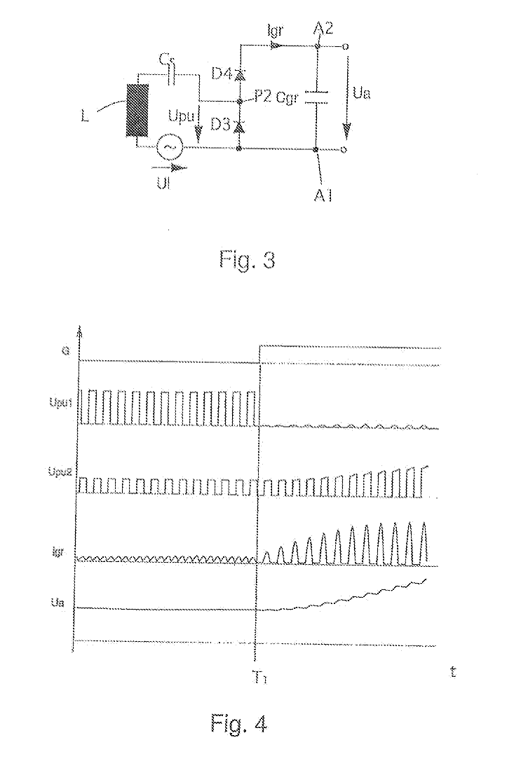

FIG. 3 shows an equivalent circuit diagram for the second mode, in which the diode is short circuited by means of the switching element and the rectifier operates as a voltage doubler;

FIG. 4 shows a current and voltage diagram.

FIG. 2 represents the circuit diagram for the secondary side rectifier according to the invention. The series resonant circuit, which is formed by the inductance L of the coil and the resonant capacitors C_{S}, is connected to the input terminals P1 and P2 of the diode bridge of the rectifier. A smoothing capacitor is connected to the output terminals A1 and A2 of the diode bridge. A voltage source Uᵢ, which represents the induced voltage, is shown in the resonant tuned circuit.

The switching means S, with which the rectifier can be switched to and fro between a first mode and a second mode, is connected in parallel with an arbitrary diode D1 to D4. In the first mode, when the semiconductor switch S is switched off, the rectifier behaves as a B2 full bridge, as represented in FIG. 1. An output voltage

U_{A,min}=√2*Uᵢ

is then set up at the output.

If the switching means S is closed, then the potential at point P1 is set to earth, or the potential of the terminal A1, and the rectifier is in the second mode and therefore in doubling mode. If the switching means S is closed, or switched on, for long enough, an output voltage

U_{A,max}=2*√2*Uᵢ

is set up.

Depending on the on-state time, the output voltage U_{A} can therefore be regulated to an arbitrary value between the two limit values and U_{A,min} and U_{A,max}.

In the second mode, the negative half wave of the induced voltage flows through the diode D3, so that the resonant capacitor C_{S} is charged to its peak value before subsequently charging the smoothing capacitor C_{gr} during the positive half-wave via the diode D4 to the sum of the induced voltage of the positive half-wave and the resonant capacitor voltage which was stored during the negative half-wave, so that the voltage U_{A,max} is set up after a few oscillation periods.

FIG. 4 shows the voltages and currents of the switchable rectifier. While the drive signal G for the switching mode S is zero, the two poles of the tune circuit are symmetrical in push-pull. The circuit is in full-wave bridge mode. The rectifier current, which flows through the smoothing capacitor, comprises both half-periods. So long as the diode in antiparallel with the switch S conducts current, the semiconductor switch S can be switched on without voltage. Switching losses are therefore avoided.

At time T₁, the drive signal S for the switching means S is set to ONE, so that the diode D1 is short-circulated by the switching means S. From time T₁ onwards, the rectifier operates together with the capacitor C_{S} of the resonant tuned circuit as a voltage doubler. The potential of the point P1, and therefore a potential of the tuned circuit, is thereby—as represented—set to ground or a fixed potential, in so far as an upper diode is short circuited by means of the switching means S. The rectifier current I_{gr} flows in the positive half-period. Since the output voltage U_{A} at the smoothing capacitor C_{gr} cannot be doubled abruptly, the peak current increases and more power is fed to the output circuit as an average value. The output voltage U^{A} increases with the time constant which derives from the Q-factor of the overall passive circuit. The drive signal G generally has a frequency which is less than the transmission frequency of the energy transmission system. As already mentioned above, the value of the output voltage U_{A} or of the output current of the rectifier can be regulated by means of the on-state/off-state time of the semiconductor switch S.

1. A secondary side rectifier of an inductive energy transmission system, wherein the energy transmission system has a single-phase secondary side resonant circuit, which has at least one inductor and at least one capacitor and can be magnetically coupled to a primary side resonant circuit, and wherein the secondary side rectifier includes:
a B2 bridge circuit, comprising four diodes and is connected on an input side to the secondary side resonant circuit;
at least one smoothing capacitor configured to smooth an output voltage of the B2 bridge circuit; and
a switching device connected in parallel with a diode of the B2 bridge circuit to enable the diode to be short-circuited.

2. The secondary side rectifier according to claim 1, further including a control device configured to switch the switching device.

3. The secondary side rectifier according to claim 2, wherein the control device is configured to drive the switching device to regulate to a setpoint output voltage or a setpoint output current, and wherein the control device is configured to compare a measured actual output voltage or actual output current of the rectifier with the setpoint output voltage or the setpoint output current.

4. The secondary side rectifier according to claim 2, wherein the control device is configured to switch on the switching means in order to increase the output voltage by short-circuiting the associated diode.

5. The secondary side rectifier according to claim 1, wherein in a first mode, in which the switching device is switched off and the associated diode is therefore not short-circuited, the secondary side rectifier is a normal rectifier, and wherein in a second mode, in which the switching device is switched on and the associated diode is therefore short-circuited, the secondary side rectifier together with the at least one capacitor of the secondary side resonant circuit forms a voltage doubler.

6. The secondary side rectifier according to claim 5, wherein the rectifier is configured to regulate to a setpoint output voltage by switching between the two modes.

7. The secondary side rectifier according to claim 1, wherein the switching device is switched off or on over more than one oscillation period of the secondary side resonant circuit.

8. The secondary side rectifier according to claim 2, wherein the control device is configured to switch the switching device as a function of a voltage or potential at an input terminal of the B2 bridge circuit, as a function of the current flowing through the switching device, or as a function of both.

9. The secondary side rectifier according to claim 8, wherein the control device only opens the switching device when the current through the switching device is zero or almost zero.

10. The secondary side rectifier according to claim 2, wherein the control device is configured to determine an unswitched potential at an input terminal to the B2 bridge and to synchronize a drive signal of the switching device with a profile of the potential.

11. The secondary side rectifier according to claim 10, wherein the control device is configured to switch the switching device only when the potential has a value greater than half a measured actual output voltage of the rectifier.

12. An energy transmission system, comprising the secondary side rectifier according to claim 1.

13. A pickup for a single-phase energy transmission system, the pickup including the secondary side rectifier according to claim 1.
